(19) United States
(12) Patent Application Publication
(10) Pub. No.: US 2010/0090912 A1
(43) Pub. Date: Apr. 15, 2010

(54) Multi-frequency antenna and an electronic device having the multi-frequency antenna thereof

(75) Inventors: Chien-Hung Lin, Taipei Hsien (TW); Yuh-Yuh Chiang, Taipei Hsien (TW); Yuan-Li Chang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/461,222

(22) Filed: Aug. 5, 2009

(30) Foreign Application Priority Data
Oct. 15, 2008 (TW) 097139622

(51) Int. Cl. H01Q 1/38; H01Q 1/24

(52) U.S. Cl. 343/702; 343/700 MS

(57) ABSTRACT

A multi-frequency antenna for wireless signal transmission of an electronic device is disclosed. The multi-frequency antenna comprises a base board, a radiating element, a grounding element, a shorting element, and a feeding point. The radiating element, the grounding element, and the shorting element are disposed on the base board. The shorting element comprises a first end and a second end; the first end is connected to the radiating element and the second end is connected to the grounding element; wherein, a first slot is disposed between the radiating element and the shorting element. The feeding point is used to feed a signal; wherein the feeding point is substantially disposed between one edge of the base board and the shorting element.

### BACKGROUND OF THE INVENTION

1. Field of the Invention

The present invention relates to a multi-frequency antenna, and more particularly, to a multi-frequency antenna which enables broadband transmission through slot adjustments.

2. Description of the Related Art

With technology advancement, wireless transmission system has become prevalent amongst electronic products. However, the traditional antenna can no longer satisfy the needs for the transmission process of large data volume, such as the multi-media files; therefore, an antenna with a larger transmission bandwidth is needed.

The prior art technology discloses a type of antenna. Please refer to FIG. 1A. FIG. 1A is a schematic drawing of a prior art antenna 90 disclosed in U.S. Pat. No. 6,812,892 B2. The antenna 90 of the prior art comprises a radiating element 91; a connecting element 92; a grounding element 93 and a feeding point F. The connecting element 92 comprises the first end 921 and the second end 922. The first end 921 is connected to the radiating element 91; the second end 922 is connected to the grounding element 93. The antenna 90 is able to feed signals into the feeding point F for electronic signal transmission.

Next, please refer to FIG. 1B which shows the Voltage Standing Wave Ratio (VSWR) at different frequencies for the antenna 90 as shown in FIG. 1A. As shown in FIG. 1B that the antenna 90 can only operate in the frequency range about 2.5 GHz and 5.5 GHz. Take frequency 2.5 GHz for example, the bandwidth of the antenna 90 at this frequency is approximately 250 MHz, the center frequency is approximately 2450 MHz, therefore the ratio is approximately (250 MHz/2450 MHz)=10.2%. As a result, the antenna 90 has limited transmission frequency bands and cannot sustain the frequency bandwidth requirements of the present multi-frequency antenna.

Therefore, it is desirable to provide a new multi-frequency antenna design in order to solve the aforementioned problem.

### SUMMARY OF THE INVENTION

A main object of the present invention is to provide a multi-frequency antenna which enables broadband transmission through slot adjustments.

Another object of the present invention is to provide an electronic device which comprises the multi-frequency antenna.

In order to achieve the above objectives, the electronic device according to an embodiment of the invention comprises a multi-frequency antenna and a wireless signal module. The multi-frequency antenna is electrically coupled with the wireless signal module. The multi-frequency antenna comprises a base board, a radiating element, a grounding element, a shorting element, and a feeding point. The radiating element, the grounding element and the shorting element are disposed on the base board and the grounding element is used for grounding the multi-frequency antenna. The shorting element comprises a first end and a second end; the first end is connected to the radiating element and the second end is connected to the grounding element; wherein, a first slot is disposed between the radiating element and the shorting element. The feeding point is used to feed a signal; wherein the feeding point is substantially disposed between one edge of the base board and the shorting element.

Other objects, advantages, and novel features of the invention will become more apparent from the following detailed description when taken in conjunction with the accompanying drawings.

### BRIEF DESCRIPTION OF THE DRAWINGS

FIG. 1A is a schematic drawing of an antenna of the prior art.

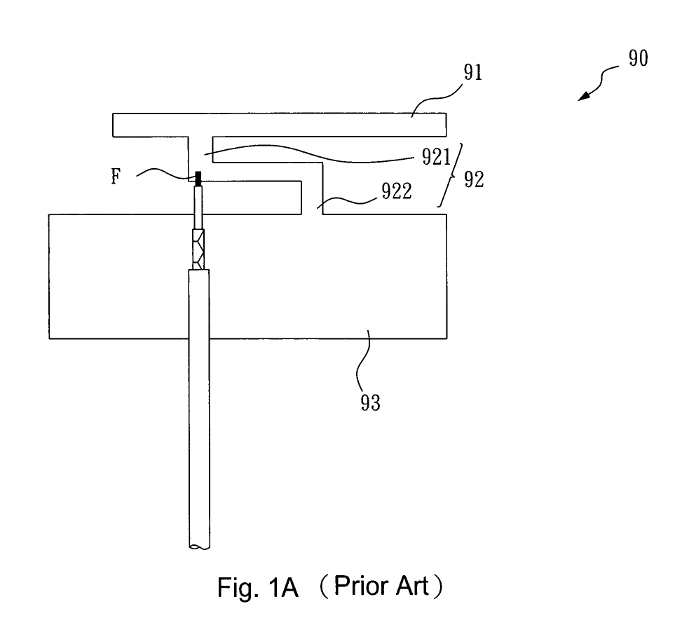

FIG. 1B shows the VSWR at different frequencies of the antenna shown in FIG. 1A.

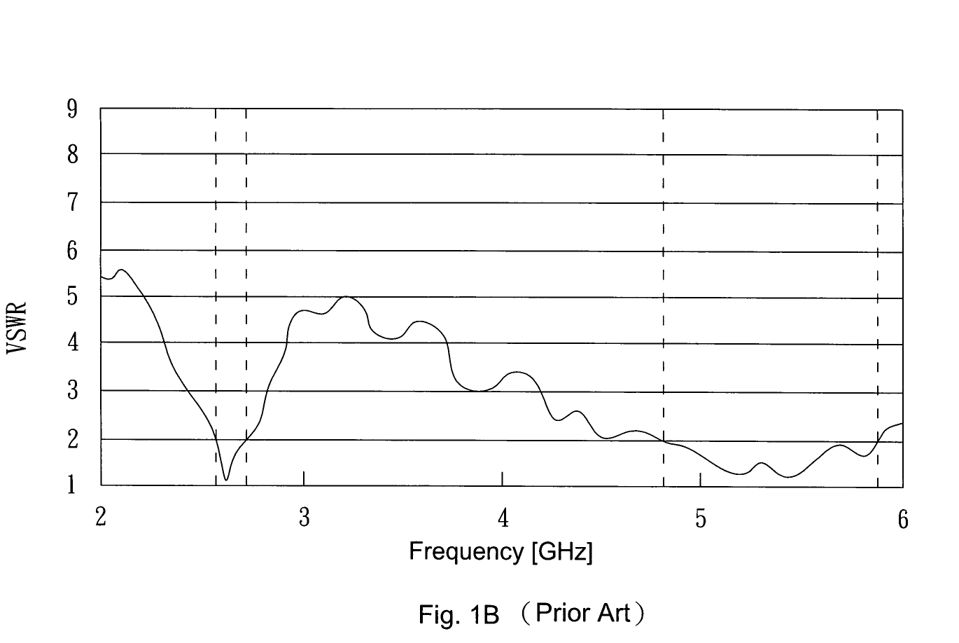

FIG. 2A is a schematic drawing of a first embodiment of a multi-frequency antenna of the invention.

FIG. 2B shows the VSWR at different frequencies of the embodiment according to the invention shown in FIG. 2A.

FIG. 2C shows the efficiency at different frequencies of the embodiment according to the invention shown in FIG. 2A.

FIG. 2D shows the radiation pattern on a horizontal plane of the embodiment according to the invention shown in FIG. 2A.

FIG. 3A is a schematic drawing of a second embodiment of a multi-frequency antenna of the invention.

FIG. 3B shows the VSWR at different frequencies of the embodiment according to the invention shown in FIG. 3A.

FIG. 4A is a schematic drawing of a third embodiment of a multi-frequency antenna of the invention.

FIG. 4B shows the VSWR at different frequencies of the embodiment according to the invention shown in FIG. 4A.

FIG. 5A is a schematic drawing of a fourth embodiment of a multi-frequency antenna of the invention.

FIG. 5B shows the VSWR at different frequencies of the embodiment according to the invention shown in FIG. 5A.

FIG. 6A is a schematic drawing of a fifth embodiment of a multi-frequency antenna of the invention.

FIG. 6B shows the VSWR at different frequencies of the embodiment according to the invention shown in FIG. 6A.

FIG. 7A is a schematic drawing of a sixth embodiment of a multi-frequency antenna of the invention.

FIG. 7B shows the VSWR at different frequencies of the embodiment according to the invention shown in FIG. 7A.

FIG. 8A is a schematic drawing of a seventh embodiment of a multi-frequency antenna of the invention.

FIG. 8B shows the VSWR at different frequencies of the embodiment according to the invention shown in FIG. 8A.

FIG. 9 shows a functional block diagram of an electronic device according to the invention.

### DETAILED DESCRIPTION OF THE PREFERRED EMBODIMENT

The advantages and innovative features of the invention will become more apparent from the following preferred embodiments.

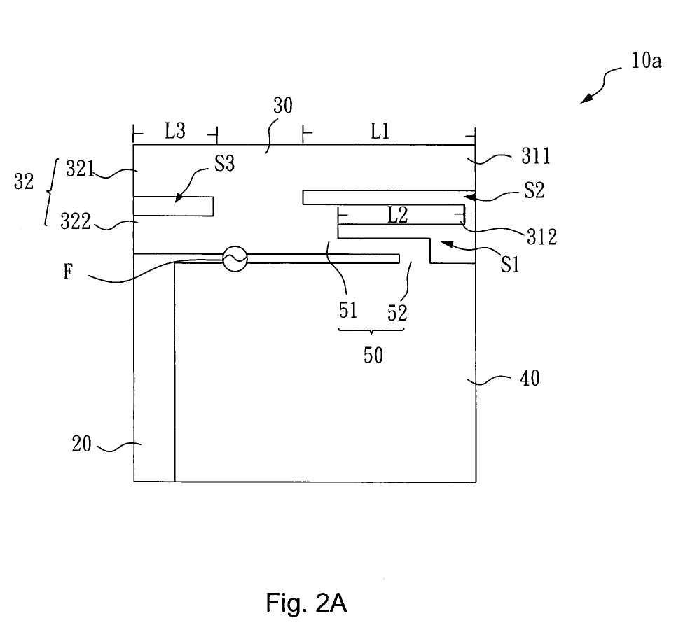

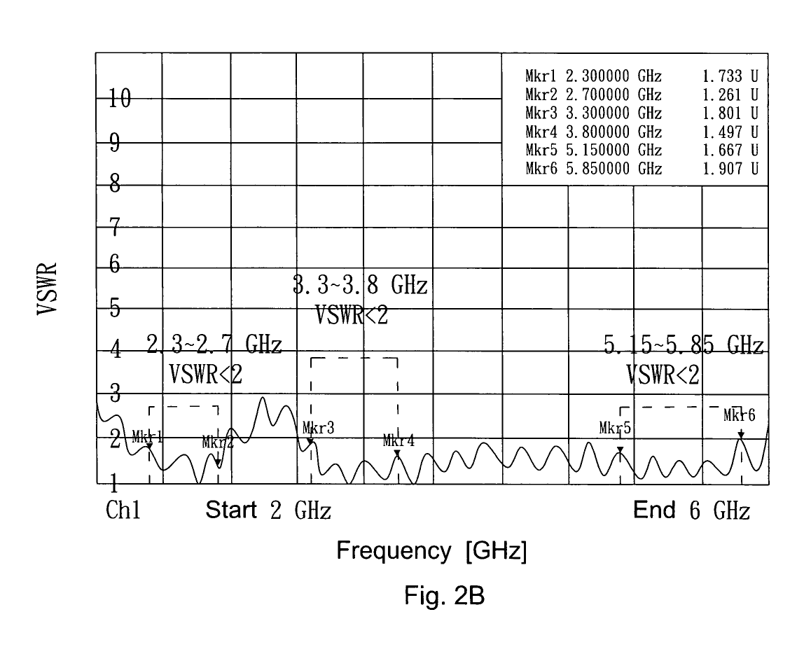

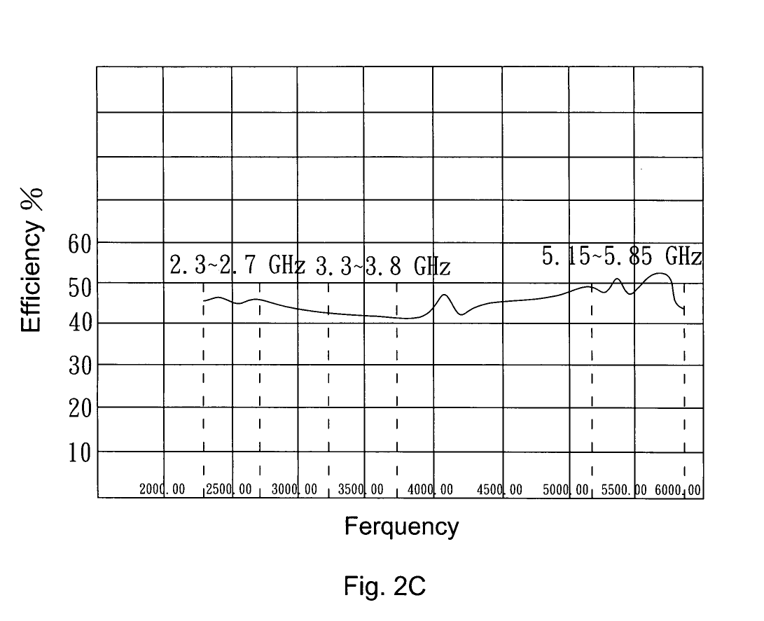

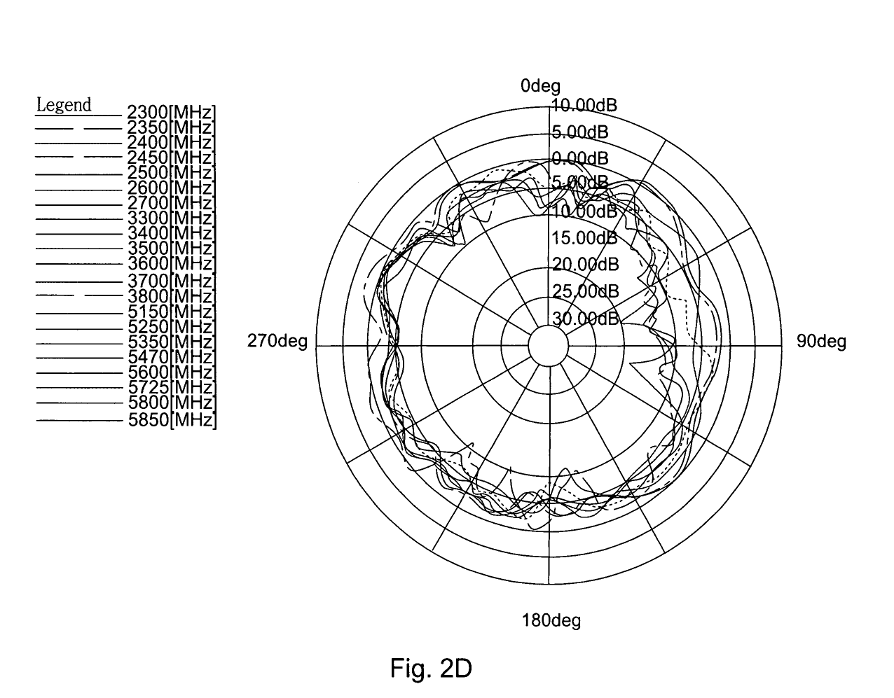

Please refer to FIG. 2A. FIG. 2A is a schematic drawing of a first embodiment of a multi-frequency antenna of the invention.

In the first embodiment, a multi-frequency antenna 10a is a flat board structure. The multi-frequency antenna 10a comprises a base board 20, a radiating element 30, a grounding element 40, a shorting element 50, and a feeding point F. The base board 20 can be a printed circuit board (PCB), a plastic board, or a glass fiber board, but the base board 20 of the invention is not only limited to these materials. The radiating element 30, the grounding element 40, and the shorting element 50 can either be printed directly onto the base board 20, or they can be produced as a separate iron piece and then attached to the baseboard 20. When current is fed into the radiating element 30, the radiating element 30 emits radiation energy. The radiating element 30 comprises a first radiation area 311, a second radiation area 312, and a matching element 32. The matching element 32 comprises a first matching area 321 and a second matching area 322. The grounding element 40 is used for grounding the multi-frequency antenna 10a. The shorting element 50 comprises a first end 51 and a second end 52; the first end 51 is connected to the radiating element 30 and the second end 52 is connected to the grounding element 40.

A first slot S1 is mounted between the radiating element 30 and the shorting element 50; a second slot S2 is mounted between the first radiation area 311 and the second radiation area 312; a third slot S3 is mounted between the first matching area 321 and the second matching area 322. The second slot S2 and the third slot S3 are substantially parallel to the first radiation area 311. The matching impedance of the radiating element 30 can be tuned by adjusting the length of the first slot S1, the second slot S2, and the third slot S3 to yield different resonance frequency bands. In order to obtain a desirable effect from the resonance, both the length of the first slot S1 and the length L2 of the second radiation area 312 must exceed half the length L1 of the first radiation area 311, and the length of the third slot S3 must exceed half the length L3 of the first matching area 321. Also, the height of the second radiation area 312 must exceed the height of the first slot S1; the height of the second matching area 322 must exceed the height of the third slot S3.

The multi-frequency antenna 10a further comprises the feeding point F; the feeding point F is substantially disposed between the edge of the base board 20 and the shorting element 50. In the first embodiment of the invention, the feeding point F is mounted on the radiating element 30, and is substantially mounted at the midpoint between the first end 51 of the shorting element 50 and the edge of matching element 32. The feeding point F is electrically coupled with a feeding wire (not shown) to feed the electric signals. The feeding wire can be a RF cable, but the invention is not limited to this material.

Through the above mentioned slots and the configuration of the multi-frequency antenna 10a, a frequency band at approximately 2 GHz can be resonated by the first radiation area 311; a frequency band at approximately 3 GHz can be resonated by the second radiation area 312; a frequency band at approximately 5 GHz can be resonated by the second matching area 322;

Next, please refer to FIG. 2B˜FIG. 2D simultaneously. FIG. 2B shows the VSWR at different frequencies of the embodiment according to the invention shown in FIG. 2A. FIG. 2C shows the efficiency at different frequencies of the embodiment according to the invention shown in FIG. 2A. FIG. 2D shows the radiation pattern on a horizontal plane of the embodiment according to the invention shown in FIG. 2A.

It is apparent from FIG. 2B that through the above mentioned slots and the configuration of the multi-frequency antenna 10a, frequency bands can be operated at approximately 2.3 GHz˜2.7 GHz, 3.3 GHz˜3.8 GHz, and 5.15 GHz˜5.85 GHz. It can be seen from FIG. 2C that the efficiency of the frequency bands at approximately 2.3 GHz˜2.7 GHz, 3.3 GHz˜3.8 GHz, and 5.15 GHz˜5.85 GHz is over 40%, therefore the multi-frequency antenna 10a possesses a good transmission efficiency. Lastly, it is apparent from FIG. 2D that the multi-frequency antenna 10a is an omnidirectional antenna. Therefore the multi-frequency antenna 10a of the invention has a better transmission ability as compared with the antenna 90 of the prior art.

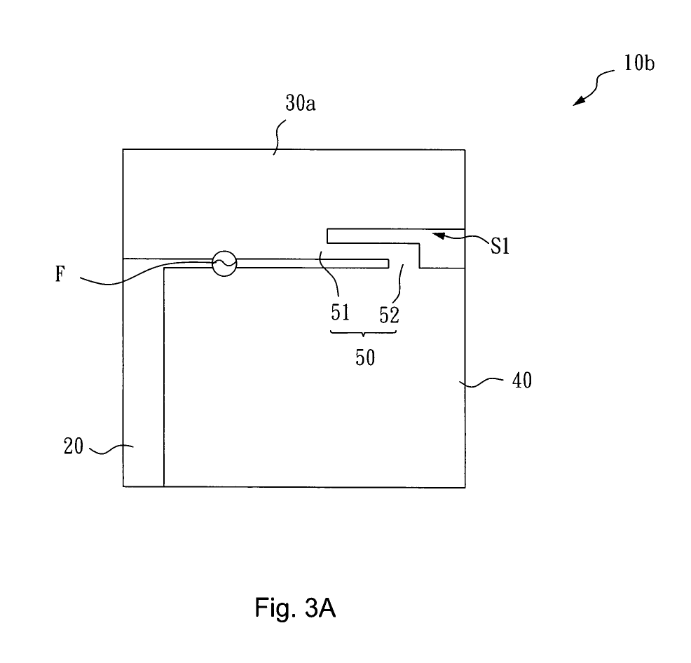

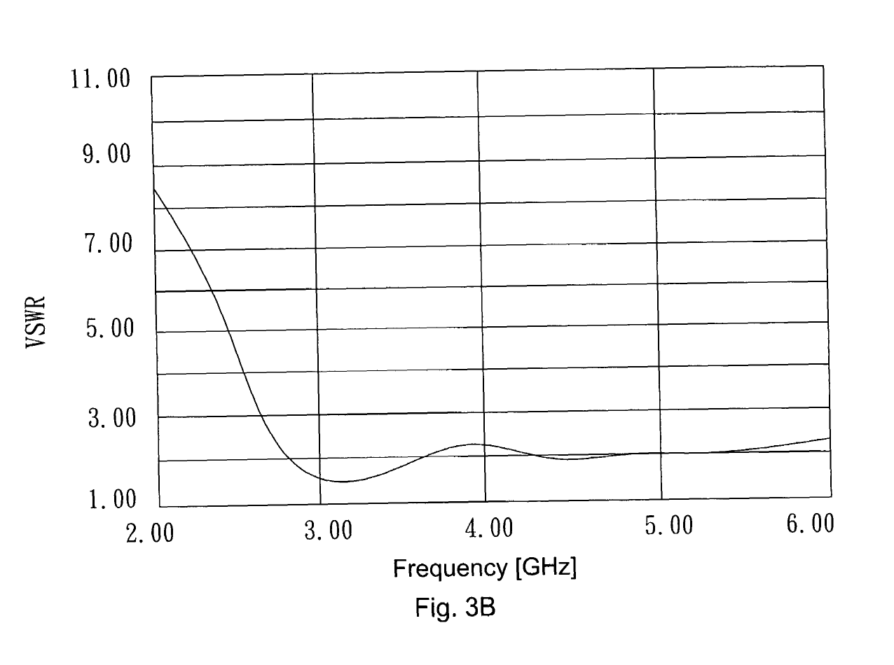

The multi-frequency antenna 10a of the invention is not only limited to the configuration as mentioned in the first embodiment. Next, please refer to FIG. 3A˜3B for the diagrams relating to a second embodiment of the invention. FIG. 3A is a schematic drawing of the second embodiment for the multi-frequency antenna of the invention. FIG. 3B shows the VSWR at different frequencies of the embodiment according to the invention shown in FIG. 3A.

In the second embodiment of the invention, the radiating element 30a of a multi-frequency antenna 10b is entirely formed of a metal board. By comparing the second embodiment with FIG. 2A, it is clear that the radiating element 30a does not comprise the second slot S2 and the third slot S3. In this configuration, the multi-frequency antenna 10b has the VSWR values as shown in FIG. 3B. The multi-frequency antenna 10b can have an operating frequency band from 2.8 GHz to 6 GHz. Therefore the multi-frequency antenna 10b of the invention has a wider range of operating frequency bands as compared with the antenna 90 of the prior art.

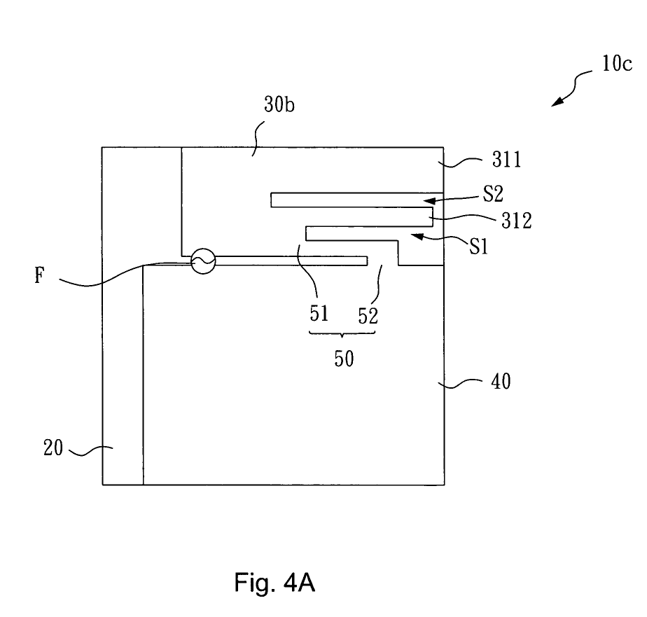

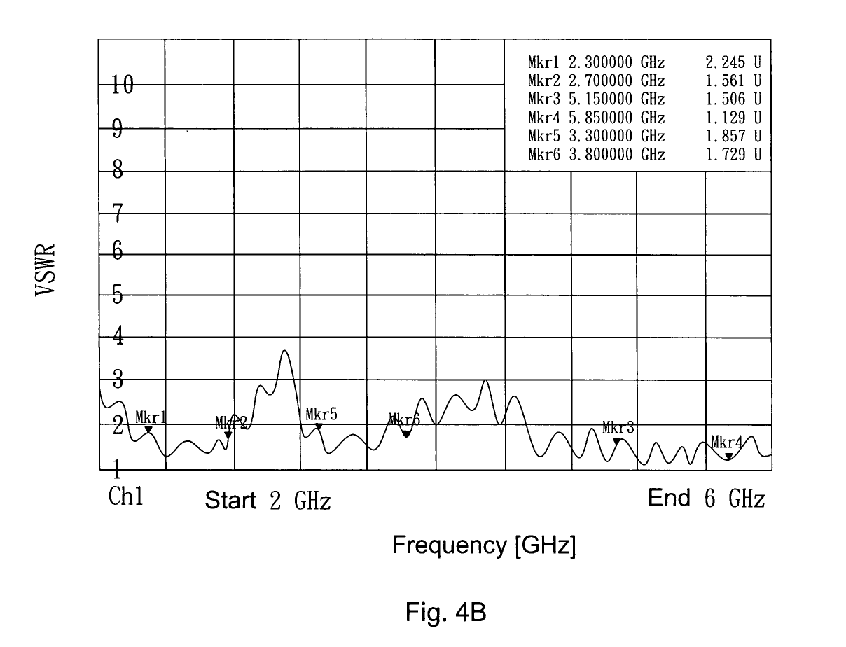

Next, please refer to FIG. 4A-4B for the diagrams relating to a third embodiment of the invention. FIG. 4A is a schematic drawing of the third embodiment for the multi-frequency antenna of the invention. FIG. 4B shows the VSWR at different frequencies of the embodiment according to the invention shown in FIG. 4A.

In the third embodiment of the invention, the radiating element 30b of a multi-frequency antenna 10c only comprises the first radiation area 311 and the second radiation area 312, and does not comprise the matching element 32 as shown in FIG. 2A. In this configuration, the multi-frequency antenna 10c has the VSWR as shown in FIG. 4B. Through resonance, the multi-frequency antenna 10c can also yield frequency bands at approximately 2.7 GHz, 3.5 GHz˜3.8 GHz, and 5 GHz.

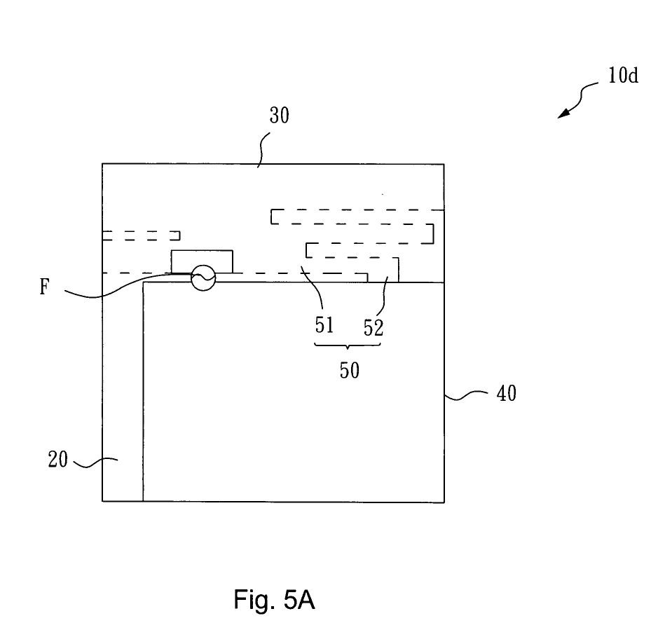

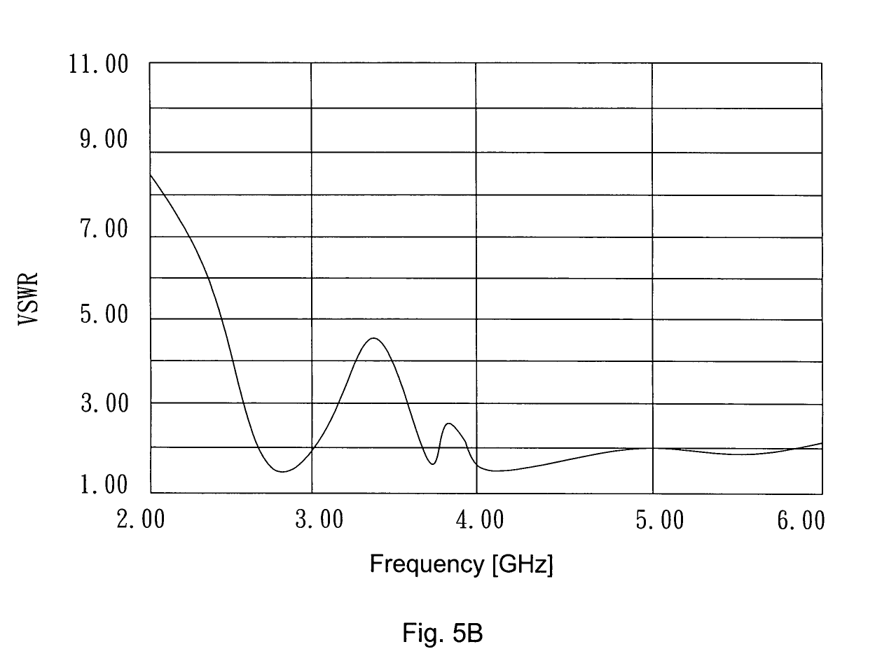

Next, refer to FIG. 5A˜5B for the diagrams relating to a fourth embodiment of the invention. FIG. 5A is a schematic drawing of the fourth embodiment of the multi-frequency antenna for the invention. FIG. 5B shows the VSWR at different frequencies of the embodiment according to the invention shown in FIG. 5A.

In the fourth embodiment of the invention, the feeding point F and the radiating element 30 of a multi-frequency antenna 10d are mounted on opposite surfaces of the base board 20. The feeding point F is substantially located between the edge of the base board 20 and the projection of the shorting element 50. The grounding element 40 is extended to the opposite surface of the base board 20. In this configuration, the multi-frequency antenna 10d has the VSWR as shown in FIG. 5B. The multi-frequency antenna 10d can yield resonance frequency bands at approximately 2.8 GHz and above 3.8 GHz.

Take note that the shape and position of the slots for the invention are not only limited to the above mentioned configurations.

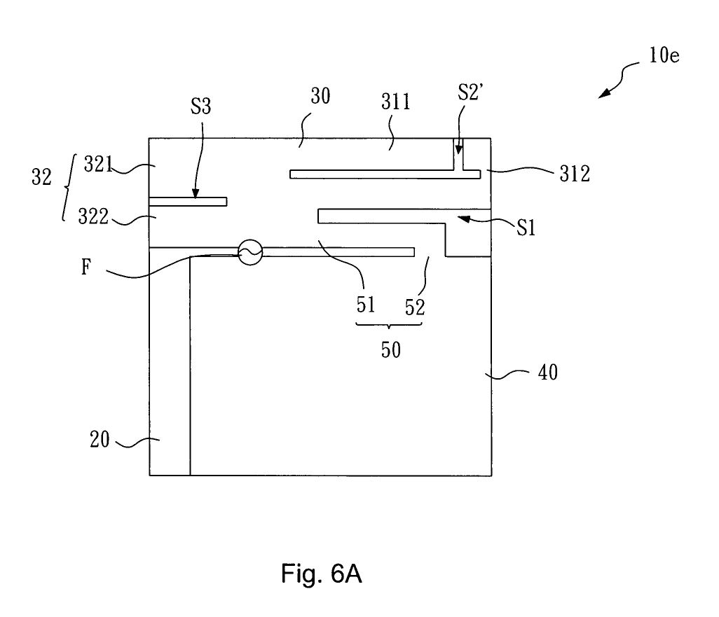

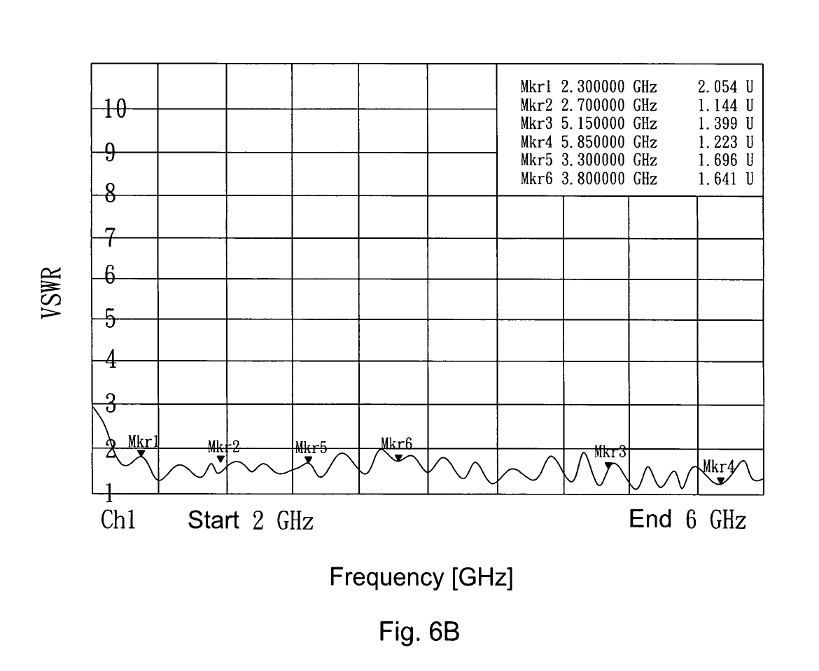

Next, please refer to FIG. 6A˜6B for the diagrams relating to a fifth embodiment of the invention. FIG. 6A is a schematic drawing of the fifth embodiment of the multi-frequency antenna for the invention. FIG. 6B shows the VSWR at different frequencies of the embodiment according to the invention shown in FIG. 6A.

In the fifth embodiment of the invention, the shape of a second slot S2′ of a multi-frequency antenna 10e is different from the second slot S2 as mentioned in the previous embodiments. The second slot S2′ is L-shaped, wherein the opening is substantially perpendicular to the first radiation area 311. Therefore, a frequency band at approximately 3 GHz can be resonated by the first radiation area 311; a frequency band at approximately 2 GHz can be resonated by the second radiation area 312. In this configuration, the multi-frequency antenna 10e has the VSWR as shown in FIG. 6B. Through resonance, the multi-frequency antenna 10e can also create operable frequency bands at approximately 2 GHz, 3 GHz, and 5 GHz.

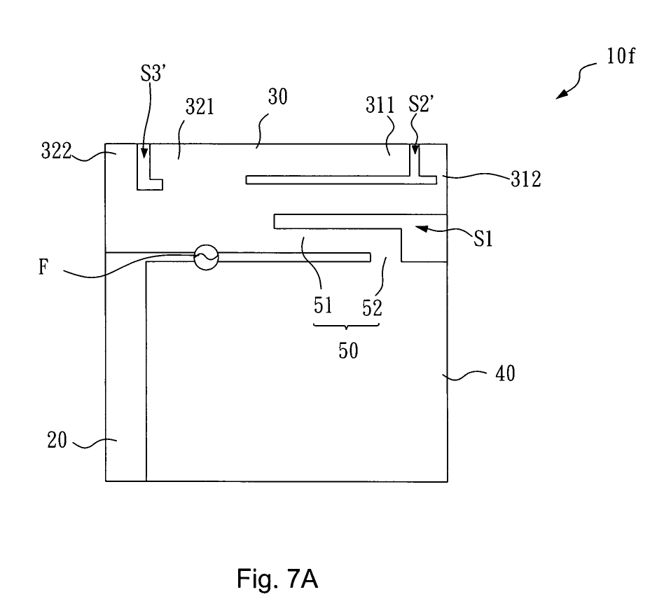

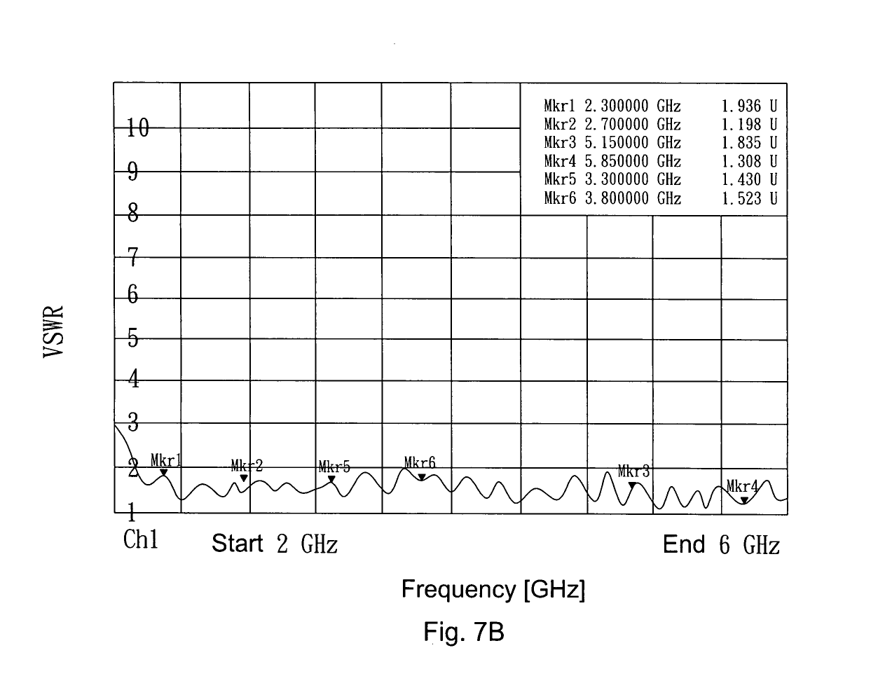

Next, please refer to FIG. 7A˜7B for the diagrams relating to a sixth embodiment of the invention. FIG. 7A is a schematic drawing of the sixth embodiment of the multi-frequency antenna for the invention. FIG. 7B shows the VSWR at different frequencies of the embodiment according to the invention shown in FIG. 7A.

In the sixth embodiment of the invention, the shape of a third slot S3′ of a multi-frequency antenna 10f is also L-shaped, and it is substantially perpendicular to the first radiation area 311. In this configuration, the multi-frequency antenna 10f has the VSWR as shown in FIG. 7B. Through resonance, the multi-frequency antenna 10f can also yield operable frequency bands at approximately 2 GHz, 3 GHz, and 5 GHz.

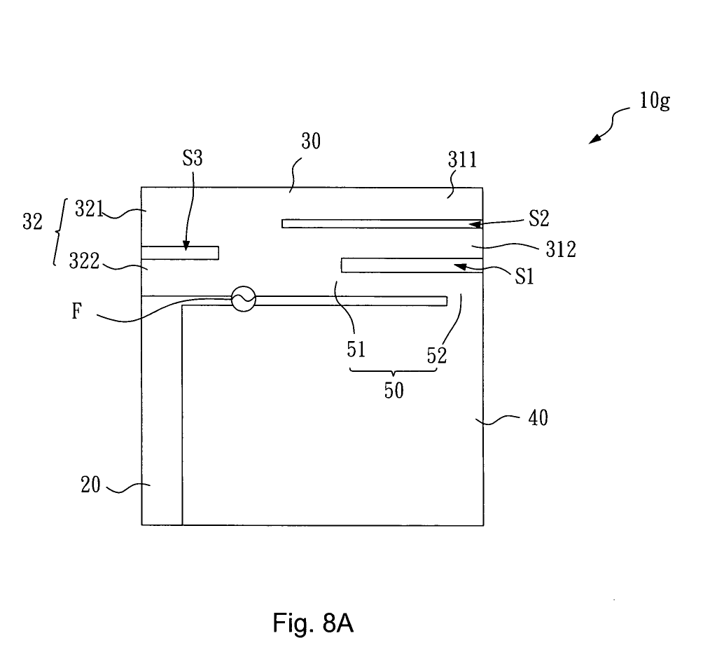

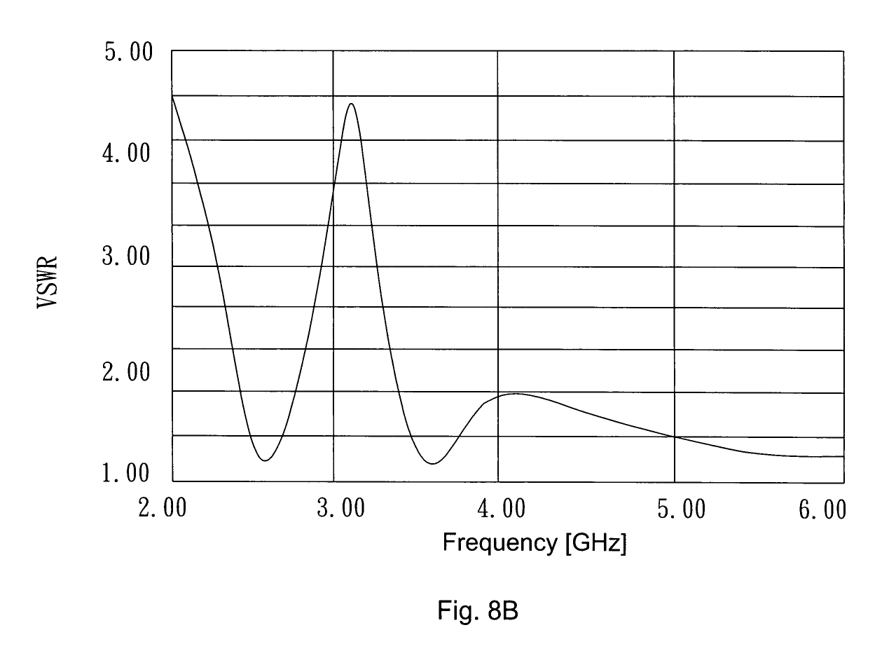

Next, please refer to FIG. 8A˜8B for the diagrams relating to a seventh embodiment of the invention. FIG. 8A is a schematic drawing of the seventh embodiment of the multi-frequency antenna. FIG. 8B shows the VSWR at different frequencies of the embodiment according to the invention shown in FIG. 8A.

The position of the connection between the shorting element 50 and the grounding element 40 can be adjusted. In the seventh embodiment of the invention, the connection between the second end 52 and the grounding element 40 of a multi-frequency antenna 10g is closely located to a bottom of the grounding element 40. In this configuration, the multi-frequency antenna 10g has the VSWR as shown in FIG. 8B. Through resonance, the multi-frequency antenna 10g can also yield operable frequency bands at approximately 2 GHz, 3 GHz, and 5 GHz.

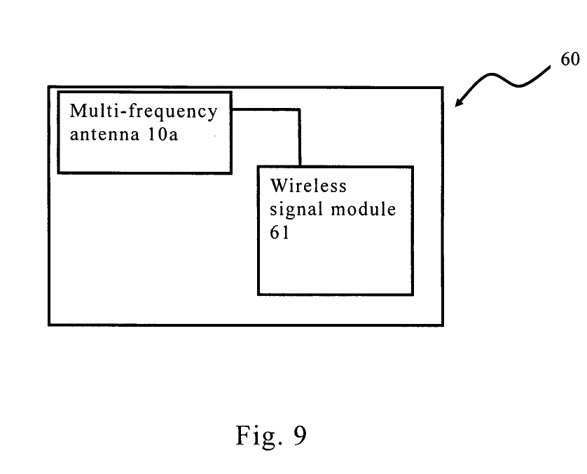

Lastly, refer to FIG. 9 for a functional block diagram of an electronic device according to an embodiment of the invention.

In one embodiment, an electronic device 60 can be a device such as a laptop computer, but the invention is not only limited to this device. As shown in FIG. 9, the electronic device 60 of the invention comprises the multi-frequency antenna 10a and a wireless signal module 61. The electronic device 60 can be electrically coupled with the wireless signal module 61 by feeding a RF cable (not shown) to the multi-frequency antenna 10a, so that signals of the multi-frequency antenna 10a can be transmitted or received by the wireless signal module 61. As a result, the electronic device 60 is able to receive or transmit wireless signal to other devices (not shown) by means of the multi-frequency antenna 10a, thus enabling wireless communication.

Take note that the device 60 is not only limited to comprise the multi-frequency antenna 10a. In order to receive or transmit wireless signals at various frequency bands, the multi-frequency antenna 10a can be replaced by anyone of the multi-frequency antennas 10b˜10g for different design requirements.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A multi-frequency antenna comprising:
a base board;
a radiating element disposed on the base board;
a grounding element disposed on the base board and used for grounding the multi-frequency antenna;
a shorting element disposed on the base board, wherein the shorting element comprises a first end and a second end; the first end is connected to the radiating element and the second end is connected to the grounding element; wherein, a first slot is disposed between the radiating element and the shorting element, and the first slot is used to adjust operating frequency bands of the multi-frequency antenna; and
a feeding point used to feed an electric signal, wherein the feeding point is substantially disposed between one edge of the base board and the shorting element.

2. The multi-frequency antenna as claimed in claim 1, wherein the radiating element further comprises a first radiation area and a second radiation area; a second slot is mounted between the first radiation area and the second radiation area, wherein the second slot is used for adjusting the operating frequency bands of the multi-frequency antenna.

3. The multi-frequency antenna as claimed in claim 2, wherein the length of the second slot exceeds half the length of the first radiation area.

4. The multi-frequency antenna as claimed in claim 2, wherein the second slot comprises an opening, and the opening is substantially perpendicular or parallel to the first radiation area.

5. The multi-frequency antenna as claimed in claim 2, wherein the radiating element further comprises a matching element, wherein the matching element comprises a first matching area and a second matching area; a third slot is mounted between the first matching area and the second matching area, wherein the third slot is used for adjusting the operating frequency bands of the multi-frequency antenna.

6. The multi-frequency antenna as claimed in claim 5, wherein the length of the third slot exceeds half the length of the first matching area.

7. The multi-frequency antenna as claimed in claim 5, wherein the third slot is substantially perpendicular or parallel to the first radiating area.

8. The multi-frequency antenna as claimed in claim 1, wherein the feeding point and the radiating element on the base board can locate either on the same surface, or locate on opposite surfaces.

9. The multi-frequency antenna as claimed in claim 1, wherein the second end of the shorting element is connected to a bottom of the grounding element.

10. The multi-frequency antenna as claimed in claim 1, wherein the radiating element, the grounding element and the shorting element can either be printed directly onto the base board, or they can be produced as a separate iron piece and then attached to the base board.

11. An electronic device having a multi-frequency antenna capable of wireless transmission; the electronic device comprising:
a wireless signal module; and
a multi-frequency antenna comprising:
a base board;
a radiating element disposed on the base board;
a grounding element disposed on the base board and used for grounding the multi-frequency antenna;
a shorting element disposed on the base board, wherein the shorting element comprises a first end and a second end; the first end is connected to the radiating element and the second end is connected to the grounding element; wherein, a first slot is disposed between the radiating element and the shorting element, and the first slot is used to adjust operating frequency bands of the multi-frequency antenna; and
a feeding point used to feed an electric signal, wherein the feeding point is substantially disposed between one edge of the base board and the shorting element.

12. The electronic device as claimed in claim 11, wherein the radiating element further comprises a first radiation area and a second radiation area; a second slot is mounted between the first radiation area and the second radiation area, wherein the second slot is used for adjusting the operating frequency bands of the multi-frequency antenna.

13. The electronic device as claimed in claim 12, wherein the length of the second slot exceeds half the length of the first radiation area.

14. The electronic device as claimed in claim 12, wherein the second slot comprises an opening, and the opening is substantially perpendicular or parallel to the first radiation area.

15. The electronic device as claimed in claim 12, wherein the radiating element further comprises a matching element, wherein the matching element comprises a first matching area and a second matching area; a third slot is mounted between the first matching area and the second matching area, wherein the third slot is used for adjusting the operating frequency bands of the multi-frequency antenna.

16. The electronic device as claimed in claim 15, wherein the length of the third slot exceeds half the length of the first matching area.

17. The electronic device as claimed in claim 15, wherein the third slot is substantially perpendicular or parallel to the first radiating area.

18. The electronic device as claimed in claim 11, wherein the feeding point and the radiating element on the base board can locate either on the same surface, or on opposite surfaces.

19. The electronic device as claimed in claim 11, wherein the second end of the shorting element is connected to a bottom of the grounding element.

20. The electronic device as claimed in claim 11, wherein the radiating element, the grounding element and the shorting element can either be printed directly onto the base board, or they can be produced as a separate iron piece and then attached to the base board.
